(19) United States
(12) Patent Application Publication
(10) Pub. No.: US 2009/0133444 A1
(43) Pub. Date: May 28, 2009

(54) Method of manufacturing optical board

(75) Inventors: Sang-Hoon Kim, Gunpo-si (KR); Je-Gwang Yoo, Yongin-si (KR); Han-Seo Cho, Yuseong-gu (KR); Joon-Sung Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/149,517

(22) Filed: May 2, 2008

(30) Foreign Application Priority Data
Nov. 27, 2007 (KR) 10-2007-0121690

(51) Int. Cl. C03B 37/022

(52) U.S. Cl. 65/386

(57) ABSTRACT

A method of manufacturing an optical board is disclosed. The method of manufacturing an optical board may include stacking an optical waveguide core layer over a first optical waveguide cladding layer, forming an inclined surface by diffracting a laser with a mask to remove a portion of the optical waveguide core layer, and stacking a reflective layer over the inclined surface.

### CROSS-REFERENCE TO RELATED APPLICATIONS

This application claims the benefit of Korean Patent Application No. 10-2007-0121690 filed with the Korean Intellectual Property Office on Nov. 27, 2007, the disclosure of which is incorporated herein by reference in its entirety.

### BACKGROUND

1. Technical Field

The present invention relates to a method of manufacturing an optical board.

2. Description of the Related Art

In apparatus such as mobile devices or network devices where high-speed data transmission is required, an optical board may be used, which includes wiring that enables the transmission of both electrical signals and optical signals.

The optical wiring used in an optical board can be fabricated from a polymer having a low light transmissivity. The optical wiring may include an optical waveguide core layer, which is the portion by which signals are transferred, and which can have a rectangular cross section having a width and thickness of about 50 μm, and an optical waveguide cladding layer surrounding the core layer. The optical waveguide core layer can have a refractive index higher than that of the optical waveguide cladding layer, to readily transfer optical signals. Either end of an optical waveguide core layer included in an optical board can have an inclination of about 45 degrees, to enable connection between the optical wiring and optical components (e.g. light emitting components and light receiving components), and can include on its surface a mirror coated with metal.

In the related art, these inclined surfaces are formed using dicing and laser equipment, etc., but this entails low productivity. Also, in the related art, existing equipment for manufacturing regular boards cannot be used in manufacturing optical boards.

### SUMMARY

An aspect of the invention provides a method of manufacturing an optical board, in which a laser used in existing processes for manufacturing printed circuit boards can be utilized in processing the inclined surfaces of an optical waveguide core layer.

Another aspect of the invention provides a method of manufacturing an optical board, which includes stacking an optical waveguide core layer over a first optical waveguide cladding layer, forming an inclined surface by diffracting a laser with a mask to remove a portion of the optical waveguide core layer, and stacking a reflective layer over the inclined surface.

After the stacking of the reflective layer, the method may further include stacking a second optical waveguide cladding layer surrounding the optical waveguide core layer.

The method may further include, after the stacking of the second optical waveguide cladding layer, forming a circuit pattern on the first and second optical waveguide cladding layers.

Yet another aspect of the invention provides a method of manufacturing an optical board, which includes surrounding an optical waveguide core layer with an optical waveguide cladding layer, forming an inclined surface by diffracting a laser with a mask to remove a portion of the optical waveguide cladding layer and a portion of the optical waveguide core layer, and stacking a reflective layer over the inclined surface.

The method may further include, after the stacking of the reflective layer, filling a filler in portions where the portion of the optical waveguide cladding layer and the portion of the optical waveguide core layer are removed.

An operation of forming a circuit pattern on a surface of the optical waveguide cladding layer may also be included, after the operation of filling the filler.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart for a method of manufacturing an optical board according to an embodiment of the invention.

FIG. 2, FIG. 3, FIG. 4, FIG. 5, FIG. 6, FIG. 7, FIG. 8, FIG. 9, and FIG. 10 are drawings representing a process flow diagram for a method of manufacturing an optical board according to an embodiment of the invention.

FIG. 11 is a flowchart for a method of manufacturing an optical board according to another embodiment of the invention.

FIG. 12, FIG. 13, FIG. 14, FIG. 15, FIG. 16, FIG. 17, FIG. 18, and FIG. 19 are drawings representing a process flow diagram for a method of manufacturing an optical board according to another embodiment of the invention.

### DETAILED DESCRIPTION

The method of manufacturing an optical board according to certain embodiments of the invention will be described below in more detail with reference to the accompanying drawings. Those elements that are the same or are in correspondence are rendered the same reference numeral regardless of the figure number, and redundant explanations are omitted.

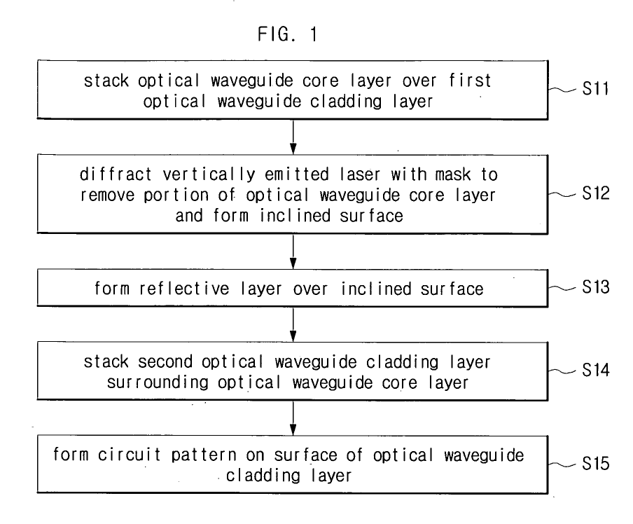

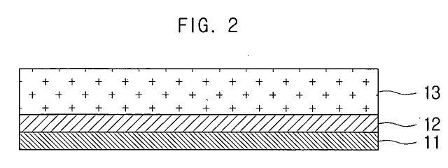

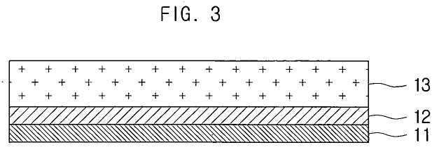

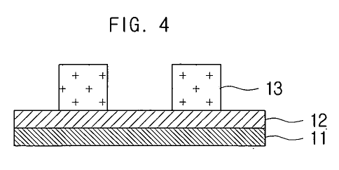

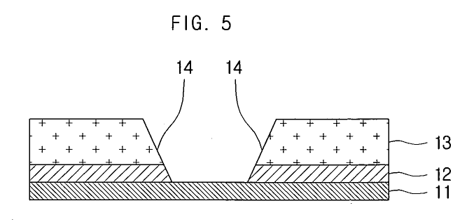

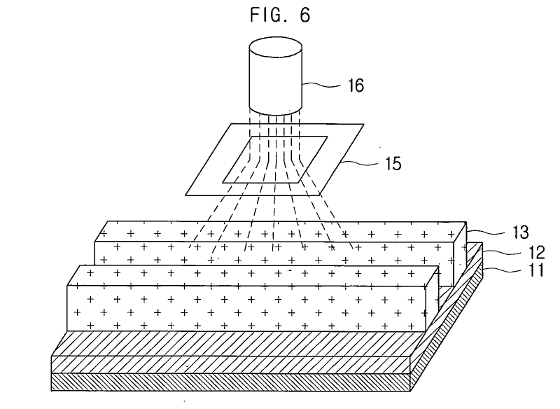

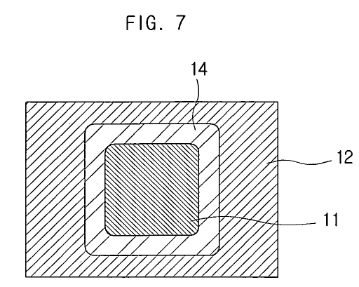

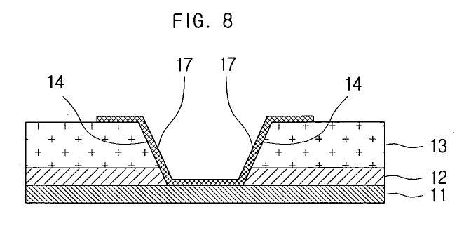

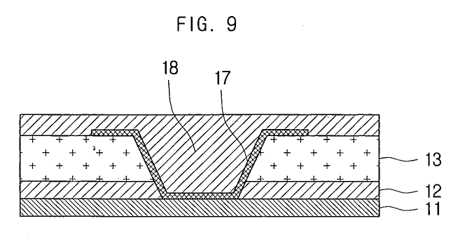

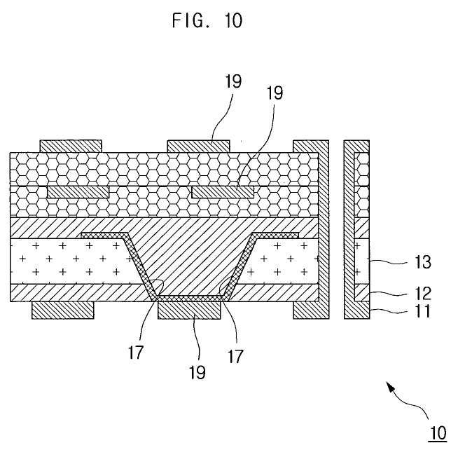

FIG. 1 is a flowchart for a method of manufacturing an optical board according to an embodiment of the invention, and FIG. 2 through FIG. 10 are drawings representing a process flow diagram for a method of manufacturing an optical board according to an embodiment of the invention. In FIGS. 2 to 10, there are illustrated an optical board 10, a metal plate 11, a first optical waveguide cladding layer 12, an optical waveguide core layer 13, inclined surfaces 14, a mask 15, a laser device 16, a reflective layer 17, a second optical waveguide cladding layer 18, and circuit patterns 19.

Operation S11 may include stacking an optical waveguide core layer over a first optical waveguide cladding layer. The first optical waveguide cladding layer 12 can be made of a resin material, and may thus be stacked over a metal layer 11 serving as a carrier. In cases where the metal layer 11 is a thin layer of copper, the metal layer 11 may also be used later in forming a circuit pattern.

As in the example shown in the cross-sectional view of FIG. 2, the first optical waveguide cladding layer 12 may be stacked over the metal layer 11, and the optical waveguide core layer 13 may be stacked over the first optical waveguide cladding layer 12. The first optical waveguide cladding layer 12 and the optical waveguide core layer 13 have different refractive indexes, and light may be transferred through the optical waveguide core layer 13.

The first optical waveguide cladding layer 12 and the optical waveguide core layer 13 can employ those materials commonly used in the relevant field of art.

The optical waveguide core layer 13 can also be patterned in accordance with a desired path of light. If the optical waveguide core layer 13 is photosensitive, it can be patterned using exposure and development processes, according to the width and path of the transmitted light. FIG. 3 is a cross-sectional view after patterning. While the drawing in FIG. 3 is substantially the same as that shown in FIG. 2, the side-elevational view for FIG. 3, as illustrated in FIG. 4, shows how only portions of the optical waveguide core layer 13 may remain, to be used as two paths.

Operation S12 may include diffracting a vertically emitted laser with a mask to remove portions of the optical waveguide core layer and form inclined surfaces. This operation will be described with reference to FIGS. 5 to 7.

As in the example shown in FIG. 6, a laser emitted from a laser device 16 can be diffracted by a mask 15. The diffraction causes the laser to disperse, and the intensity of the dispersed beam causes the optical waveguide core layer 13 to be shaped as shown in the example cross-sectional view in FIG. 5. In FIG. 5, it is seen that inclined surfaces 14 may be formed by the laser.

The laser used in this particular embodiment is a carbon dioxide laser. However, any of various other lasers may be selected that are capable of removing a portion of the optical waveguide core layer 13.

It can be effective to use a carbon dioxide laser as in this embodiment, because carbon dioxide lasers are used in forming via holes, in processes for manufacturing boards. As such, the same laser device 16 can be used, as in this particular embodiment, in the process for forming the inclined surfaces 14 in the optical waveguide core layer 13, as well as in a subsequent process for forming via holes.

The laser device 16 in this particular embodiment emits the laser vertically. In this way, the laser device 16 may be used without alterations in a subsequent process for forming via holes.

Operation S13 may include stacking a reflective layer over the inclined surfaces, and FIG. 8 illustrates an example of a corresponding process.

On the inclined surfaces 14, a reflective layer 17 made of metal can be formed, for example, by sputtering. The metal may be such that has a high reflectivity, examples of which include gold, copper, and silver, etc. The method used here can include a method of performing sputtering over the entire arrangement and then removing the sputtered metal other than the reflective layer 17, or a method of selectively sputtering only the reflective layer 17 using a mask. Of course, other methods for forming the reflective layer 17 over the inclined surfaces known to those skilled in the art may be applied, which may or may not utilize sputtering.

Operation S14 may include stacking a second optical waveguide cladding layer that surrounds the optical waveguide core layer, and FIG. 9 illustrates an example of a corresponding process. The second optical waveguide cladding layer 18 can be made from the same material as that of the first optical waveguide cladding layer 12. The second optical waveguide cladding layer 18 may advantageously surround all of the exposed portions of the optical waveguide core layer 13. This can provide reflection at the interfaces between the optical waveguide core layer 13 and the first and second optical waveguide cladding layers 12, 18, for light traveling within the optical waveguide core layer 13.

With the completion of operation S14, the optical waveguide core layer 13 may be completely surrounded by the first and second optical waveguide cladding layers 12, 18.

Operation S15 may include forming circuit patterns on the surfaces of the optical waveguide cladding layer, and FIG. 10 illustrates an example of a corresponding process. Since the first and second optical waveguide cladding layers 12, 18 may also be insulation layers, the circuit patterns 19 may be formed by any of a variety of methods, including semi-additive methods and subtractive methods, etc., where the circuit patterns 19 may be formed in multiple layers. The process for forming the circuit patterns 19 may further include the forming of interconnection elements, such as via holes and through-holes, etc. After proceeding with this operation, an optical board 10 may be completed, such as that of the example shown in FIG. 10.

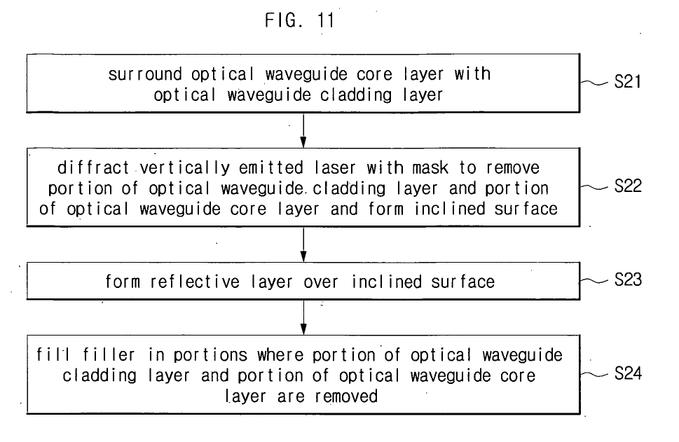

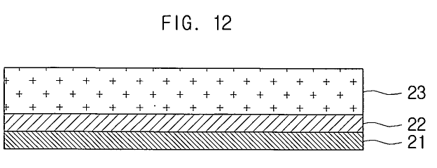

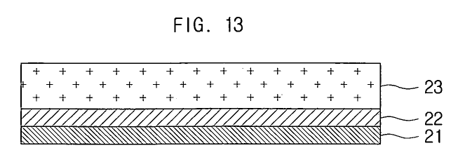

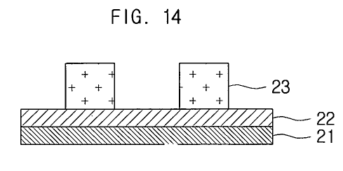

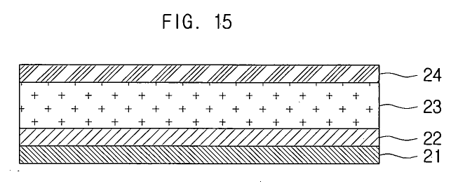

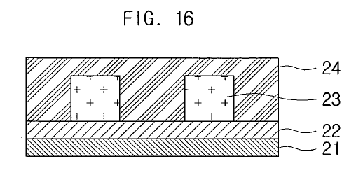

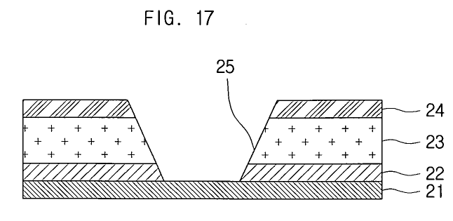

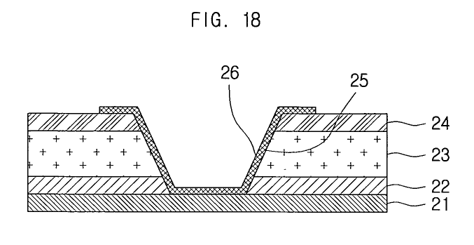

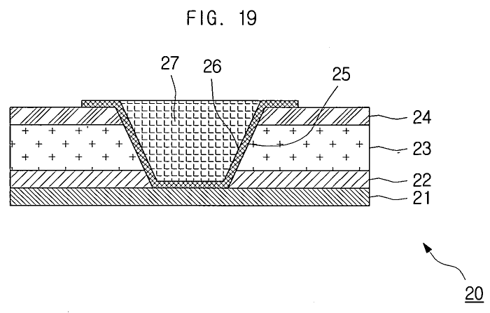

FIG. 11 is a flowchart for a method of manufacturing an optical board according to another embodiment of the invention, and FIG. 12 through FIG. 19 are drawings representing a process flow diagram for a method of manufacturing an optical board according to another embodiment of the invention. In FIGS. 12 to 19, there are illustrated an optical board 20, a metal layer 21, a first optical waveguide cladding layer 22, an optical waveguide core layer 23, a second optical waveguide cladding layer 24, inclined surfaces 25, a reflective layer 26, and a filler 27.

Operation S21 may include surrounding an optical waveguide core layer with an optical waveguide cladding layer, and FIGS. 12 to 15 illustrate an example of a corresponding process. As illustrated in FIG. 12, a first optical waveguide cladding layer 22 and an optical waveguide core layer 23 may be stacked in order over a metal layer 21. In cases where the optical waveguide core layer 23 is made from a photosensitive material, removing portions of the optical waveguide core layer 23 using exposure and development processes may result in a configuration such as that shown in FIG. 13. While the drawing in FIG. 13 is substantially the same as that shown in FIG. 12, the side-elevational view is as represented in FIG. 14. That is, two optical paths may be formed.

Afterwards, a second optical waveguide cladding layer 24 may be stacked, resulting in a configuration such as that shown in FIG. 15. FIG. 16 is a side-elevational view for FIG. 15, which shows how the first and second optical waveguide cladding layers 22, 24 may surround the optical waveguide core layer 23. Thus, light passing through the optical waveguide core layer 23 may undergo total reflection at the interfaces to the first and second optical waveguide cladding layers 22, 24.

Operation S22 may include diffracting a vertically emitted laser with a mask to remove a portion of the optical waveguide cladding and a portion of the optical waveguide core layer and form inclined surfaces. FIG. 17 illustrates an example of a corresponding process. The process illustrated in FIG. 17 may proceed in substantially the same manner as for that illustrated in FIG. 6. The result will be the inclined surfaces 25 illustrated in FIG. 17. The metal layer 21 may act as a stopper to prevent the laser from penetrating any deeper. Of course, it is possible to proceed with this process for forming the inclined surfaces 25 without using a metal layer 21, if the intensity of the laser can be adjusted with precision.

Operation S23 may include stacking a reflective layer over the inclined surfaces, and FIG. 18 illustrates an example of a corresponding process. The reflective layer 26 may be stacked by sputtering. The material used for the reflective layer 26 can be copper, gold, etc. This operation can be performed in substantially the same manner as for the previously disclosed embodiment.

Operation S24 may include filling the portions where the portion of the optical waveguide cladding layer and the portion of the optical waveguide core layer have been removed with a filler. FIG. 19 illustrates an example of a corresponding process. The material used for the filler 27 can be the same material used for the optical waveguide cladding layers 22, 24. This material can be such that has an insulating quality. If the filler 27 is not filled in, the empty gap may affect the additional processes for completing the optical board in a manner that lowers the reliability of the product.

While an optical board 20 can be completed with the finishing of operation S24, it is possible to manufacture a multilayered optical board 20, by performing additional processes of forming circuit patterns and stacking layers. The method of manufacturing a multilayered optical board 20 can be substantially the same as that illustrated for the previously disclosed embodiment described with reference to FIG. 10.

According to certain embodiments of the invention as set forth above, a laser generally used in processes for manufacturing a printed circuit board can be utilized to process the inclined surfaces of the optical waveguide core, so that an optical board may be manufactured without having to use additional new equipment.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing an optical board, the method comprising:
stacking an optical waveguide core layer over a first optical waveguide cladding layer;
forming an inclined surface by diffracting a laser with a mask to remove a portion of the optical waveguide core layer; and
stacking a reflective layer over the inclined surface.

2. The method of claim 1, further comprising, after the stacking of the reflective layer:
stacking a second optical waveguide cladding layer surrounding the optical waveguide core layer.

3. The method of claim 2, further comprising, after the stacking of the second optical waveguide cladding layer:
forming a circuit pattern on the first and second optical waveguide cladding layers.

4. A method of manufacturing an optical board, the method comprising:
surrounding an optical waveguide core layer with an optical waveguide cladding layer;
forming an inclined surface by diffracting a laser with a mask to remove a portion of the optical waveguide cladding layer and a portion of the optical waveguide core layer; and
stacking a reflective layer over the inclined surface.

5. The method of claim 4, further comprising, after the stacking of the reflective layer:
filling a filler in portions where the portion of the optical waveguide cladding layer and the portion of the optical waveguide core layer are removed.

6. The method of claim 5, further comprising, after the filling of the filler:
forming a circuit pattern on a surface of the optical waveguide cladding layer.
